(19) United States
(12) Patent Application Publication
(10) Pub. No.: US 2024/0184653 A1
(43) Pub. Date: Jun. 6, 2024

(54) SCHEDULING COMPUTER SYSTEM MAINTENANCE BASED ON KEY PERFORMANCE INDICATORS

(71) Applicant: INTERNATIONAL BUSINESS MACHINES CORPORATION, Armonk, NY (US)

(72) Inventors: Neelamadhav Gantayat, Bangalore (IN); Renuka Sindhgatta Rajan, Bengaluru (IN); Avirup Saha, Kolkata (IN); Sampath Dechu, Acton, MA (US)

(21) Appl. No.: 18/075,645

(22) Filed: Dec. 6, 2022

(51) Int. Cl. G06F 11/00; G06F 11/34

(52) U.S. Cl. CPC G06F 11/008; G06F 11/3428

(57) ABSTRACT

Scheduling IT maintenance based on key performance indicators (KPIs) includes receiving current information technology (IT) data corresponding to an IT system and current process data corresponding to a process implemented with the IT system. A suffix and time prediction model generates a suffix prediction of a likely sequence of suffixes given a prefix of the process and a time prediction of time remaining to complete the likely sequence of suffixes, wherein the suffix and time predictions are based on based on the IT data and current process data; A load on each of step of the process is determined based on the suffix and time prediction; One or more KPI metrics of the process is determined based on the load of each step. An IT maintenance schedule output is generated based on the one or more KPI metrics.

### BACKGROUND

This disclosure relates to information technology (IT) systems and, more particularly, to scheduling IT maintenance based on key performance indicators (KPIs) of a process.

Enterprises such as businesses, governmental entities, and other organizations of all sizes increasingly rely on IT to automate various processes. For example, a business may use an IT system to fully automate a process of receiving, validating, and processing orders for shipment of the business' products. Once a product is shipped, the business may use IT-implemented tracking of the shipment and for processing payment for the product. An enterprise that relies on an IT system to automate one or more processes critical to the enterprise's mission can ill afford an extensive or prolonged failure of the IT system. Accordingly, many if not most enterprises regularly schedule planned downtime of an IT system to maintain and/or upgrade the software running on the enterprises' IT system. Nonetheless, even planned downtime can be costly. By some current estimates, the average cost of downtime for a typical enterprise is nearly $10,000 per minute, though the estimate can vary widely among different enterprises due to many factors.

### SUMMARY

In one or more embodiments, a method of scheduling IT maintenance includes receiving, by a hardware processor, current IT data corresponding to an IT system and current process data corresponding to a process implemented with the IT system. The method includes generating, by a suffix and time prediction model implemented by the hardware processor, a suffix prediction of a likely sequence of suffixes given a prefix of the process and a time prediction of time remaining to complete the likely sequence of suffixes. The suffix and time prediction is based on the IT data and current process data. The method includes determining, with the hardware processor, a load on each of step of the process based on the suffix and time prediction. The method includes determining, with the hardware processor, one or more KPI metrics of the process based on the load of each step. The method includes generating an output, with the hardware processor, the output comprising an IT maintenance schedule based on the one or more KPI metrics.

In one aspect, the IT maintenance schedule comprises a plurality of dynamically determined downtime windows. The downtime windows are determined to maximize the expected availability of IT resources such that the effect on processes implemented by the IT system are minimized as much as feasible during the preforming IT maintenance on the IT system.

In another aspect, a prediction is generated of the number of different process steps of one or more processes that can be performed during downtime(s) when the IT maintenance is performed.

In another aspect, a time that is likely optimal for performing maintenance on a particular IT system or IT infrastructure can be predicted.

In one or more embodiments, a system includes a processor configured to initiate executable operations as described within this disclosure.

In one or more embodiments, a computer program product includes one or more computer readable storage mediums having program code stored thereon. The program code is executable by a processor to initiate executable operations as described within this disclosure.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1 illustrates an example of a computing environment that is capable of implementing an information technology maintenance scheduling (ITMS) framework.

FIG. 2 illustrates an example architecture for the executable ITMS framework illustrated in FIG. 1.

FIG. 3 illustrates an example method of operation of the ITMS framework illustrated in FIGS. 1 and 2.

FIGS. 4A-4C illustrate example event suffix and time remaining predictions generated by a machine learning model implemented in the example architecture illustrated in FIG. 2.

FIG. 5 schematically illustrates dynamic determination of downtime windows determined based on example event suffix and time remaining predictions.

FIG. 6 illustrates an example graphical user interface (GUI) view of an IT maintenance schedule generated by the ITMS framework illustrated in FIGS. 1 and 2.

### DETAILED DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to information technology (IT) systems and, more particularly, to scheduling IT maintenance based on key performance indicators (KPIs) of a process. As noted already, notwithstanding the benefit of regular maintenance and upgrades of an IT system, even regularly scheduled IT system downtime can be costly for an enterprise. One reason is that an enterprise's IT teams may not consider the consequence (e.g., financial and/or reputational) of IT downtime on one or more processes of the enterprise. IT downtime that adversely affects one or more enterprise processes (e.g., product shipment, order processing) can reduce revenue, result in a loss of opportunities, and/or otherwise negatively impact the enterprise. Conventional IT maintenance on an IT system is typically performed at regularly scheduled intervals. Even if the scheduling is designed to lessen the impact on processes supported by the IT system, a lack of dynamic scheduling may sacrifice opportunities to perform maintenance when downtime is least likely to affect the enterprise's processes.

In accordance with the inventive arrangements described within this disclosure, methods, systems, and computer program products are provided that are capable of determining downtime for performing IT maintenance on an IT system such that the downtime is likely to have the least impact on processes supported by the IT system. Relatedly, the inventive arrangements are capable of maximizing the likely availability of IT resources while still ensuring the IT maintenance is performed timely and efficiently.

In one aspect of the inventive arrangements disclosed herein, one or more downtime windows are dynamically determined for an optimal scheduling of maintenance on an IT system software and/or infrastructure. In another aspect, the inventive arrangements predict the loads imposed on an IT system by as the IT system performs various operations (e.g., service responses to API calls) that implement the different tasks of a process (e.g., business process) at any given time. The inventive arrangements disclosed herein are capable of generating finely grained KPI metrics and combining them with expected loads on the IT system to dynamically identify suitable intervals (downtime windows) during which IT maintenance can be performed. In another aspect, the inventive arrangements are capable of performing different constrained optimization processes. The processes can take into account resource availability to maximize availability of IT resources and to maximize IT maintenance priorities.

Further aspects of the inventive arrangements are described below with reference to the figures. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

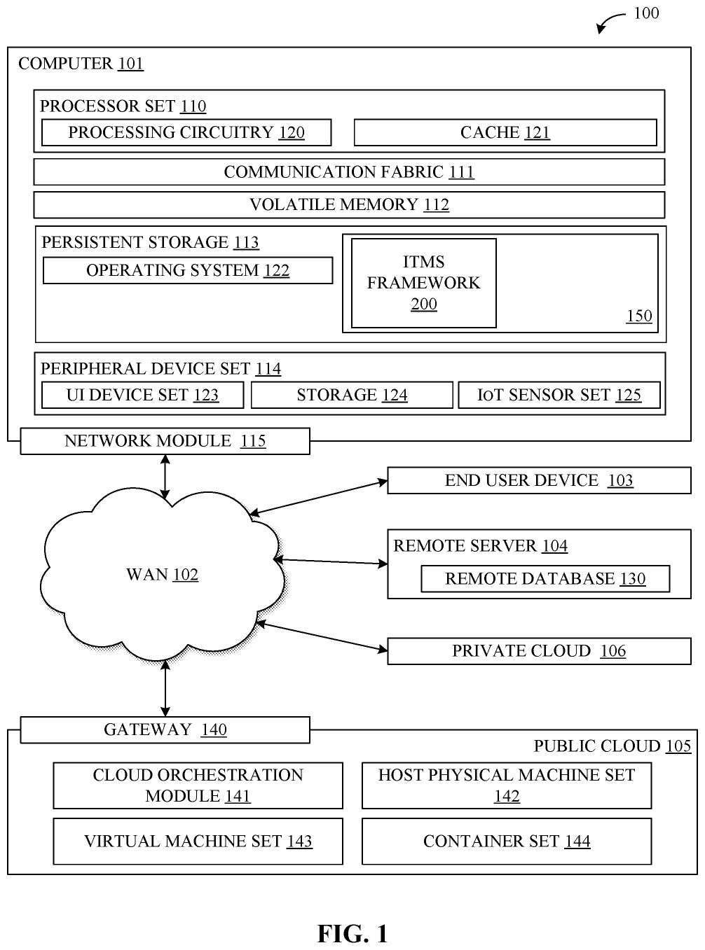

Referring to FIG. 1, computing environment 100 contains an example of an environment for the execution of at least some of the computer code in block 150 involved in performing the inventive methods, such as information technology maintenance scheduling (ITMS) framework 200 implemented as executable program code or instructions. ITMS framework 200 is capable of dynamically determining downtime windows for performing IT maintenance on an IT system such that the maintenance likely has the least impact on the processes supported by the IT system. The dynamic determination can be based on event suffix and time remaining predictions generated by machine learning model. Predictions generated by the model based on current IT data and current process data can be used to generate a maintenance schedule of the IT maintenance that is likely to maximize execution of one or more processes given the constraint imposed by IT maintenance-related downtimes. That is, though there is the constraint imposed by IT system downtime, ITMS framework 200 maximizes the use of IT resources that are available given the constraints imposed by the downtime. ITMS framework 220 utilizes equipment downtime to carry our scheduled downtime maintenance tasks, thus more effectively utilizing equipment downtime and minimizing the scheduled downtime.

Computing environment 100 additionally includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and ITMS framework 200, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (e.g., secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (e.g., where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (e.g., embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (e.g., the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (e.g., a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (e.g., private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

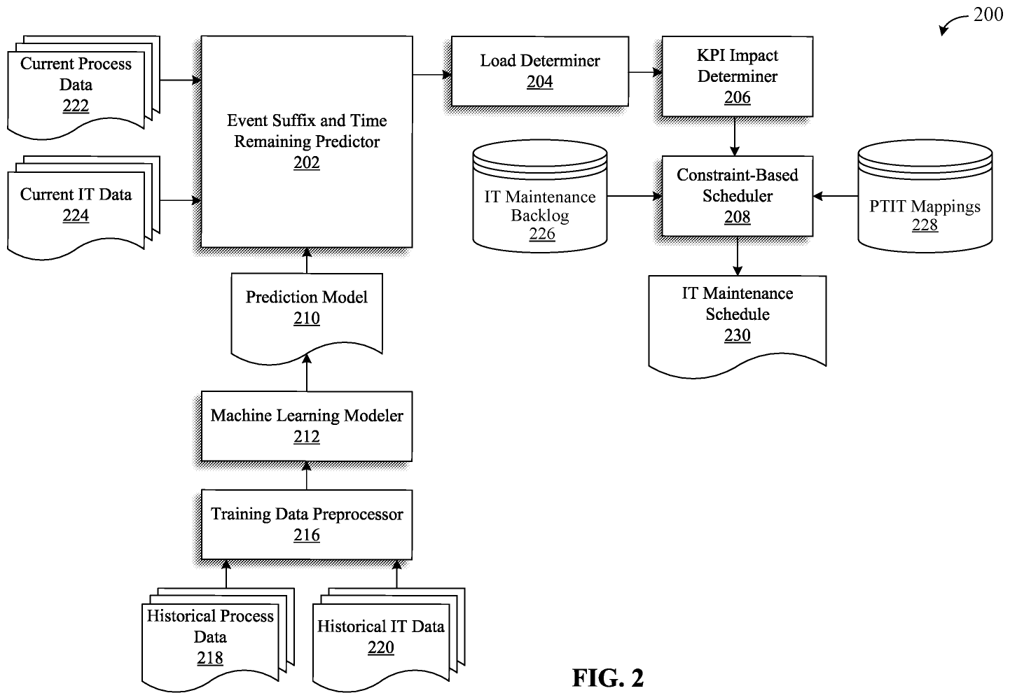

FIG. 2 illustrates an example architecture for the executable ITMS framework 200 of FIG. 1. Illustratively, in FIG. 2, the example architecture of ITMS framework 200 includes event suffix and time remaining predictor 202, load determiner 204, KPI impact determiner 206, and constraint-based scheduler 208. Event suffix and time remaining predictor 202 implements prediction model 210. Prediction model 210 is generated through machine learning implemented by machine learning modeler 212. Machine learning modeler 212 generates prediction model 210 through supervised learning using training data preprocessed by training data preprocessor 216. The training data comprises historical process data 218 and historical IT data 220.

Prediction model 210, as implemented by event suffix and time remaining predictor 202, is trained to generate event suffix and remaining time predictions. An event suffix and remaining time prediction is a sequence-to-sequence learning task. The task is two-fold. First, given a prefix—that is, a partly-complete sequence of events—a prediction is generated of the most likely suffix—that is, the most likely sequence of subsequent events. Second, the time remaining for completing the suffix is generated. Unlike conventional suffix predictors, ITMS framework 200's event suffix and time remaining predictor 202 considers current IT equipment anomalies and/or downtimes to identify the remaining time of subsequent process steps. An example processor-executable data structure for the i-th event of a sequence is the 2-tuple, eᵢ=(aᵢ, tᵢ), where aᵢ is the action of the i-th event and tᵢ is a corresponding time stamp. Various machine learning algorithms can implement prediction model 210. In certain embodiments of ITMS framework 200, prediction model 210 is implemented as a deep-learning neural network. In some embodiments, prediction model 210 is implemented as a generative adversarial network (GAN). In still other embodiments, prediction model 210 can be implemented with other machine learning algorithms.

Operatively, in the context of ITMS framework 200, event suffix and time remaining predictor 202 predicts expected sequence of process steps and the expected time remaining to complete the process steps. Given a current sequence of one or more steps of a process (labeled the prefix), event suffix and time remaining predictor 202 predicts the likely subsequent steps expected by determining a sequence of labels (the suffix) and the corresponding remaining time (duration of time of the suffixes). Thus, given an initial process step or an immediate step of a process, event suffix and time remaining predictor 202 predicts the sequence of process steps that are expected to follow and the expected time for completing the sequence of process steps.

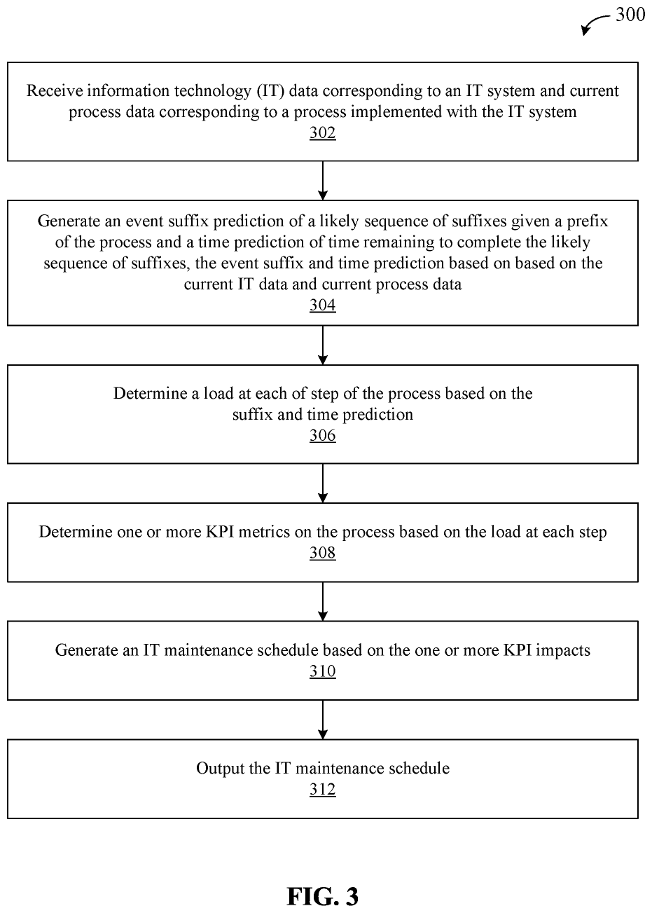

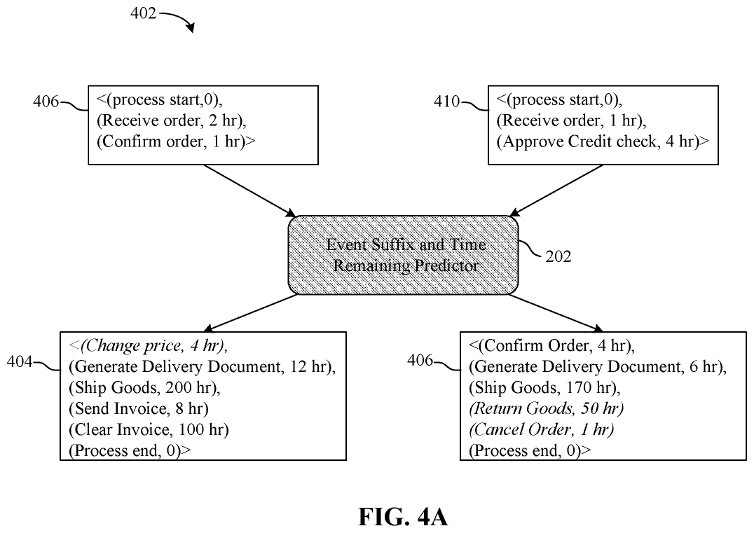

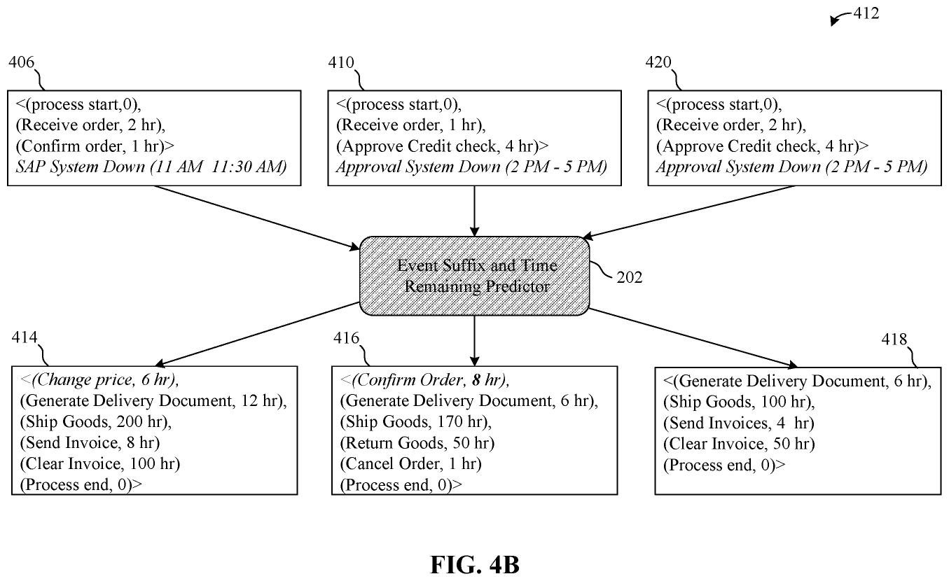

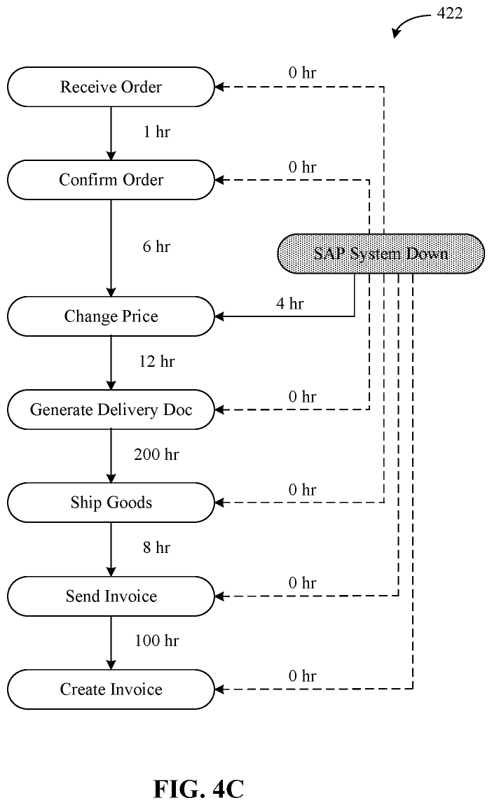

FIG. 3 illustrates an example method 300 of operation of the ITMS framework 200 of FIGS. 1 and 2. Referring to FIGS. 2 and 3 collectively, in block 302, event suffix and time remaining predictor 202 receives current IT data 222 corresponding to an IT system and current process data 224 corresponding to a process (see, e.g., FIGS. 4A-4C) implemented with the IT system.

In block 304, event suffix and time remaining predictor 202 generates an event suffix prediction of a likely sequence of suffixes (labels of process steps) given a prefix of the process (label of completed process steps) and a time prediction of time remaining to complete the likely sequence of suffixes (label of remaining process steps). The event suffix and time prediction, as generated, is a prediction based on current IT data 220 and current process data 218.

In block 306, load determiner 204 determines the load with respect to each step of the process based on the event suffix and time prediction. The load at a process step corresponds to the number of IT requests (e.g., API calls) that the services of the IT system receive in support of performing the process step. In many cases, the load with respect to a particular process step can vary based on time. The load at a process step may depend on the season of the year, the month or day, or, as is often the case, the time of day. Load determiner 204 can receive a current time, and, based on the event suffix and time prediction, determine the time remaining to complete each remaining step of a process. Correlating the times with the loads at specific times, load determiner 204 can determine the expected load with respect to each step of the process yet to be completed.

In block 308, KPI impact determiner 206 determines a KPI metric for each process step yet to be completed. A KPI metric is a measure of performance of a process implemented by the operations of the IT system, and thus is not static. The KPI can be a function of various factors, such as yearly season, environment, load on the IT system, IT anomalies, and the like. Thus, the KPI metric varies and is correlated with the load on the IT system elements implementing the process whose performance is measured by the KPI metric. ITMS framework 200 is capable of using various KPI metrics. These include volume measure KPIs, such as number of concurrent users, number of requests per second, and rate of throughput, which measures the overall load on a process. The load on a system directly influences the volume measure KPIs. Additionally, there are certain KPIs that operate on a particular business process step, as well to determine the volume. The load on different steps will influence an overall process KPI with respect to the system performing the processing. KPI impact determiner 206 determines one or more KPI metrics for each step of the process based on the load corresponding to each step. Accordingly, fine-grained KPIs can be computed with respect to a process based on the load at each step of the process.

In block 310, constraint-based scheduler 208 generates IT maintenance schedule 222 based on one or more KPI metrics determined for each step and on a mapping of process steps to elements of the IT structure that support the process. Constraint-based scheduler 208 generates IT maintenance schedule 222 with respect to pending IT maintenance tasks, retrieved from a database of IT maintenance backlog 226, and a map of process steps to the IT system elements, retrieved from a database of process-to-IT (PTIT) mappings 228. IT Maintenance schedule 230 output is generated by constraint-based scheduler 208 in block 312.

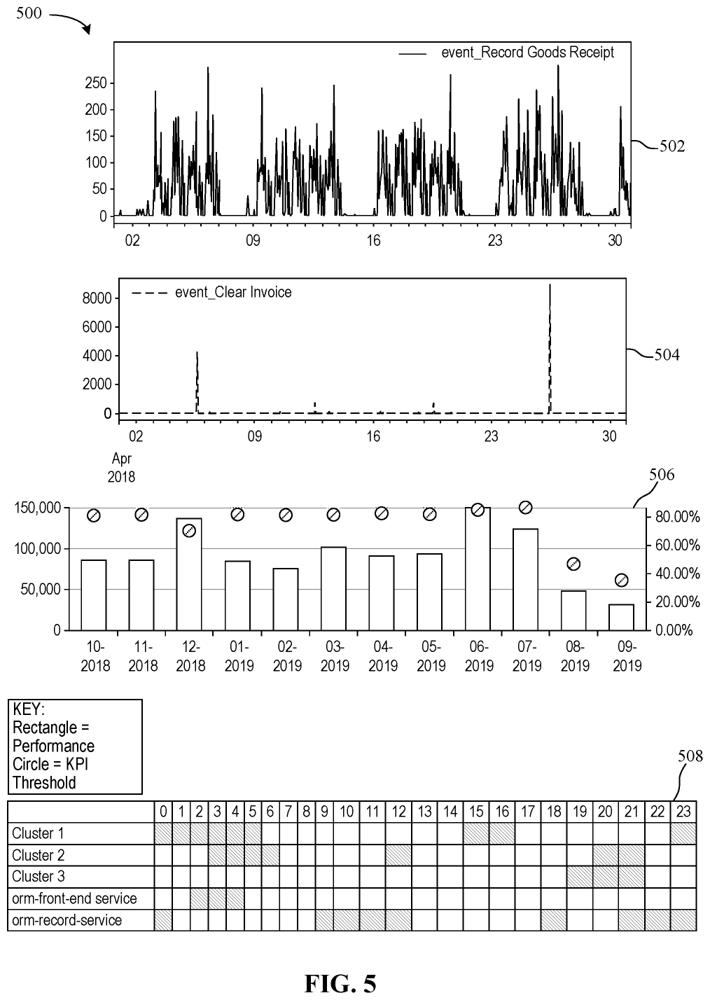

Constraint-based scheduler 208 is capable of dynamically determining a plurality of downtime windows (FIG. 5). Each downtime window can specify, for example, a specific time (e.g., hour of the day) and an allotted duration (e.g., two hours) during which one or more process steps of one or more processes are suspended to allow IT maintenance to be performed. As described below, constraint-based scheduler 208 can schedule downtimes to maximize a likelihood that a maximum of available resources of the IT system are available for concurrently executing processes during a time spanned by the downtime windows. One objective served by the dynamic determination of downtime windows is that the suspending of process steps can be timed to minimize the impact on process KPIs. The KPIs are measures of the performance of the processes implemented by the procedures, operations, functions, and the like carried out by the IT system. Constraint-based scheduler 208 can use current KPIs for optimal scheduling of IT maintenance. An optimal schedule of IT maintenance least diminishes one or more KPIs affected. Thus, IT maintenance can be performed in a manner that least interferes with the processes (as measured by the KPIs) that an enterprise is expected to perform. Constraint-based scheduler 208 is also capable of maximizing the priorities of various IT maintenance tasks, as described below.

An advantage of dynamically determining a plurality of downtime windows, is that the enterprise can respond to an IT failure or process slowdown by initiating IT maintenance during the failure or slowdown. For example, a KPI metric that measures the number of orders processed electronically by a business may change by a greater-than-threshold amount (e.g., a 20 percent or greater drop). Responding to the slowdown, ITMS framework 200, performing the above-described procedures, can dynamically revise IT maintenance scheduling to institute IT maintenance for IT system software or infrastructure that would otherwise be more intensively used but for the slowdown.

Likewise, in the event of an IT failure, ITMS framework 200 can respond by determining which IT system elements (software and/or infrastructure hardware) are affected and by dynamically scheduling downtime windows during which IT maintenance is performed with respect to the affected elements. Both with respect to the IT failure and the process slowdown, the role served by the event suffix and time prediction is to identify a cascade of successive processes steps affected and the likely duration that the steps that are affected.

FIGS. 4A-4C illustrate determination of a cascading effect of an IT failure in the context of an IT process. In the example, the IT process electronically handles process orders and shipments. The example IT process includes a set of core process steps. The core process steps—receive order, confirm order, generate deliver document, ship goods, send invoice, and clear invoice—as well as the variations are implemented by IT system that performs various operations, such as procedures, functions, service responses to API calls, API call between one or more different data systems, and the like.

FIG. 4A illustrates predictions 402 performed by event suffix and time remaining predictor 202 with respect to example process 400. Illustratively, a sequence of process steps corresponding to event suffixes 404 are predicted to follow the sequence of process steps corresponding to prefixes 406. The sequence of process steps corresponding to event suffixes 408 are predicted to follow the sequence of process steps corresponding to prefixes 410.

FIG. 4B schematically illustrates predictions 412 performed by event suffix and time remaining predictor 202 in which the predictions with respect to example process 400 are dynamically revised in response to different IT failures. One IT failure brings down the IT system that illustratively supports the process steps corresponding to suffixes 404 and prefixes 406. The IT failure illustratively affects the process step, change price. Rather, than completing the process step after 4 hours, the process step completes in 6 hours owing to the IT failure. Event suffix and time remaining predictor 202 dynamically revise the predictions, generating suffixes 414. The other IT failure brings down the Credit Approval System that supports the process steps corresponding to prefixes 410, resulting in an increase in the duration of the process step, approve credit check, from 4 hours to 8 hours. Event suffix and time remaining predictor 202 dynamically revises the predictions, generating suffixes 416. By contrast, the failure of the Credit Approval System does not affect the process steps that do not involve credit transaction, shown by suffixes 418 generated by event suffix and time remaining predictor 202 based on prefixes 420.

FIG. 4C illustrates cascading effect 422 predicted by event suffix and time remaining predictor 202 in response to the IT failure that brings down the IT system. The resulting increase in time required to perform the step change price has an effect that cascades through the process steps generate delivery document, ship goods, send invoice, and create invoice. Although, the IT failure only affects the process step change price the effect delays each of the subsequent process steps. The additional downtime creates an opportunity to perform IT maintenance on one or more of the IT system elements (software and/or hardware) used by each of the steps. Taking advantage of the additional downtime, allows IT maintenance without diminishing the KPIs of the process steps anymore than would have been the case given the IT failure.

FIG. 5 illustrates example output 500 generated with the ITMS framework 200, based on event suffix and time remaining predictions, in the context of the example business process illustrated in FIGS. 4A-4C. Output 502 (e.g., GUI), generated by load determiner 204, is a visual presentation of the IT system loads, at given times, corresponding to processing goods receipts. Output 504, also generated by load determiner 204 visually presents the IT system loads, at given times, corresponding to invoice clearances. KPI impact determiner 206 generates output 506. Output 506 is a visual presentation of distributions of process orders (POs), at given times. Output 508 is a plurality of downtime windows generated by constraint-based scheduler 208. The first column of output 508 (e.g., computer screen shot) corresponds to specific IT system elements (software and/or hardware), with the remaining columns showing one-hour intervals. The darkened blocks correspond to downtime windows dynamically generated by ITMS framework 200 based on the data visually represented in outputs 502-506.

Constraint-based scheduler 222 can comprise other features in addition to the dynamically generated downtime windows. In some embodiments, constraint-based scheduler 208 is configured to maximize the priority of multiple IT maintenance tasks, according to the following constrained optimization:

max Σ_{i,j}βᵢxᵢⱼ

where xᵢⱼ is one if maintenance task i is assigned to IT resource j and zero otherwise, and where βᵢ is the priority of the i-th task. The following constraint ensures one task is performed at a time:

$${\sum }_{j} ( {x}_{ij} {x}_{{i}^{′} j} = 1 ⇒ ( {e}_{i} < {s}_{i} , ∨ {s}_{i} > {e}_{\text{?}} ) for all i \neq {i}^{′}$$

$$\text{?} \text{indicates text missing or illegible when filed}$$

where sᵢ denotes the start time of the i-th task and eᵢ denotes the end time of the i-th task. Another constraint that tasks are scheduled within the dynamically determined windows:

$${\sum }_{i , j , k} ( {x}_{ij} = 1 ) ⇒ ( {e}_{i} < {e}_{{i}_{{w}_{k}}} ∨ {s}_{i} >= {s}_{\text{?}} ) for all i , k$$

$$\text{?} \text{indicates text missing or illegible when filed}$$

where twₖ lists the available time intervals for the respective tasks.

Another constraint ensures sequential dependency:

$${\sum }_{\text{?}} {d}_{\text{?}} ( {x}_{ij} {x}_{\text{?}} = 1 ) ⇒ {e}_{1} < {s}_{i} ,$$

$$\text{?} \text{indicates text missing or illegible when filed}$$

where dᵢᵢ, is one if there is sequential dependency and task i precedes task i′.

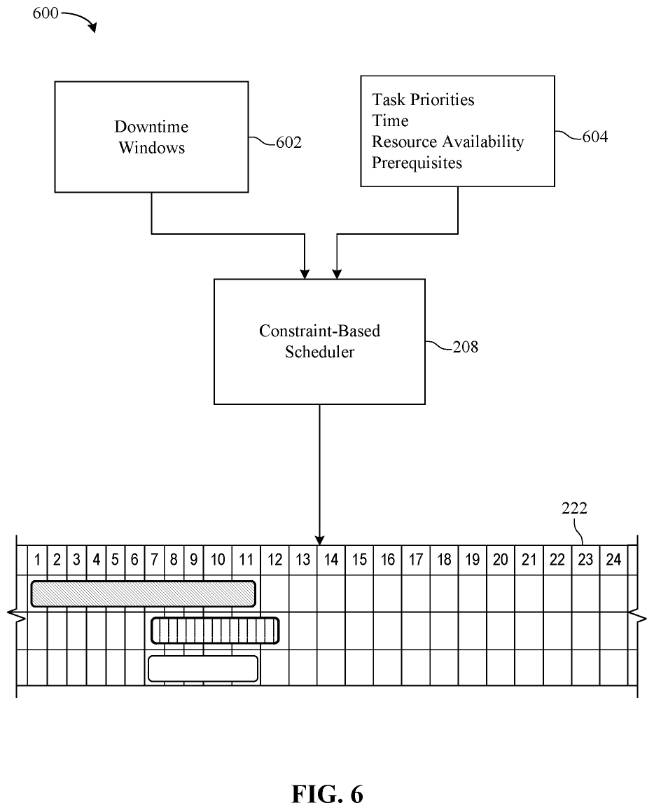

FIG. 6 schematically illustrates constraint-based scheduler 208's optimization 600 of IT maintenance schedule 230. Optimization 600 is based on downtime windows 602 optimized by constraint-based scheduler based on factors 604. Illustratively, factors 604 include task priorities, time, resource availability, and prerequisites. In the present context, time refers to the time required to finish a specified task. Resources refers to resources specifically required to carry out the task. Prerequisites are task dependencies.

In other embodiments, constraint-based scheduler 208 can perform other constrained optimizations. For example, in some embodiments, constraint-based scheduler 208 maximizes the availability of processes based on various factors.

Factors can be environmental factors, defined herein as factors external to the IT system but that nonetheless can affect the IT system and/or interfere with a process. For example, an environmental factor can be weather. Weather can affect business processes, leading to a slowdown in one or more KPIs. ITMS framework 200 can respond to detecting a KPI slowdown as described above, taking advantage of the less intensive execution of one or more processes to perform IT maintenance. An environmental factor that also affects a process may be a supply chain disruption, which causes less intensive execution of one or more processes. An environmental factor that affects the IT system directly may be a communication network disruption. The disruption would be comparable to a failure of some aspect of the IT system, causing an ITMS framework 200 response similar to that described with respect to FIGS. 4A-4C. Any disruption can be modelled by ITMS framework 200, and event suffix and time remaining predictor 202 can identify the time duration based on the disruption.

The terminology used herein is for the purpose of describing particular embodiments only and is not intended to be limiting. Notwithstanding, several definitions that apply throughout this document now will be presented.

The term “approximately” means nearly correct or exact, close in value or amount but not precise. For example, the term “approximately” may mean that the recited characteristic, parameter, or value is within a predetermined amount of the exact characteristic, parameter, or value.

As defined herein, the terms “at least one,” “one or more,” and “and/or,” are open-ended expressions that are both conjunctive and disjunctive in operation unless explicitly stated otherwise. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without user intervention.

As defined herein, the terms “includes,” “including,” “comprises,” and/or “comprising,” specify the presence of stated features, integers, steps, operations, elements, and/or components, but do not preclude the presence or addition of one or more other features, integers, steps, operations, elements, components, and/or groups thereof.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the terms “one embodiment,” “an embodiment,” “in one or more embodiments,” “in particular embodiments,” or similar language mean that a particular feature, structure, or characteristic described in connection with the embodiment is included in at least one embodiment described within this disclosure. Thus, appearances of the aforementioned phrases and/or similar language throughout this disclosure may, but do not necessarily, all refer to the same embodiment.

As defined herein, the term “output” means storing in physical memory elements, e.g., devices, writing to display or other peripheral output device, sending or transmitting to another system, exporting, or the like.

As defined herein, the term “processor” means at least one hardware circuit configured to carry out instructions. The instructions may be contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “responsive to” means responding or reacting readily to an action or event. Thus, if a second action is performed “responsive to” a first action, there is a causal relationship between an occurrence of the first action and an occurrence of the second action. The term “responsive to” indicates the causal relationship.

The term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

The terms first, second, etc. may be used herein to describe various elements. These elements should not be limited by these terms, as these terms are only used to distinguish one element from another unless stated otherwise or the context clearly indicates otherwise.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
receiving, by a hardware processor, current information technology (IT) data corresponding to an IT system and current process data corresponding to a process implemented with the IT system;
generating, by a suffix and time prediction model implemented by the hardware processor, a suffix prediction of a likely sequence of suffixes given a prefix of the process and a time prediction of time remaining to complete the likely sequence of suffixes, wherein the suffix and time prediction is based on based on the IT data and current process data;
determining, with the hardware processor, a load on each of step of the process based on the suffix and time prediction;
determining, with the hardware processor, one or more KPI metrics of the process based on the load of each step;
generating, with the hardware processor, an IT maintenance schedule based on the one or more KPI metrics; and
outputting, with the hardware processor, the IT maintenance schedule.

2. The method of claim 1, wherein the generating the maintenance schedule comprises dynamically determining a plurality of downtime windows.

3. The method of claim 2, wherein current process data corresponds to a plurality of concurrently executing processes, and wherein the determining the plurality of downtime windows maximizes a likelihood that a maximum of available resources of the IT system are available for the concurrently executing processes during the downtime windows.

4. The method of claim 3, wherein the generating the maintenance schedule comprises generating a constraint-based scheduler based on the plurality of downtime windows and at least one of a maintenance task priority, IT resource availability, and current time.

5. The method of claim 1, wherein the current IT data indicates an IT system failure, and wherein the generating the maintenance schedule to performance maintenance on IT system elements affected by the IT system failure.

6. The method of claim 1, further comprising:
receiving data indicating an environmental factor that affects the one or more KPI metrics; and
generating the maintenance schedule based on the environmental factor and the one or more KPI metrics.

7. The method of claim 6, wherein the environmental factor corresponds to at least one of a weather condition, supply chain disruption, or communication network disruption.

8. A system, comprising:
a processor configured to initiate operations including:
receiving current information technology (IT) data corresponding to an IT system and current process data corresponding to a process implemented with the IT system;
generating, by a suffix and time prediction model, a suffix prediction of a likely sequence of suffixes given a prefix of the process and a time prediction of time remaining to complete the likely sequence of suffixes, wherein the suffix and time prediction is based on based on the IT data and current process data;
determining a load on each of step of the process based on the suffix and time prediction;
determining one or more KPI metrics of the process based on the load of each step;
generating an IT maintenance schedule based on the one or more KPI metrics; and
outputting the IT maintenance schedule.

9. The system of claim 8, wherein the generating the maintenance schedule comprises dynamically determining a plurality of downtime windows.

10. The system of claim 9, wherein current process data corresponds to a plurality of concurrently executing processes, and wherein the determining the plurality of downtime windows maximizes a likelihood that a maximum of available resources of the IT system are available for the concurrently executing processes during a time spanned by the downtime windows.

11. The system of claim 10, wherein the generating the maintenance schedule comprises generating a constraint-based scheduler based on the plurality of downtime windows and at least one of a maintenance task priority, IT resource availability, and current time.

12. The system of claim 8, wherein the current IT data indicates an IT system failure, and wherein the generating the maintenance schedule to performance maintenance on IT system elements affected by the IT system failure.

13. The system of claim 8, wherein the processor is configured to initiate operations further including:
receiving data indicating an environmental factor that affects the one or more KPI metrics; and
generating the maintenance schedule based on the environmental factor and the one or more KPI metrics.

14. A computer program product, the computer program product comprising:
one or more computer-readable storage media and program instructions collectively stored on the one or more computer-readable storage media, the program instructions executable by a processor to cause the processor to initiate operations including:
receiving current information technology (IT) data corresponding to an IT system and current process data corresponding to a process implemented with the IT system;
generating, by a suffix and time prediction model, a suffix prediction of a likely sequence of suffixes given a prefix of the process and a time prediction of time remaining to complete the likely sequence of suffixes, wherein the suffix and time prediction is based on based on the IT data and current process data;
determining a load on each of step of the process based on the suffix and time prediction;
determining one or more KPI metrics of the process based on the load of each step;
generating an IT maintenance schedule based on the one or more KPI metrics; and
outputting the IT maintenance schedule.

15. The computer program product of claim 14, wherein the generating the maintenance schedule comprises dynamically determining a plurality of downtime windows.

16. The computer program product of claim 15, wherein current process data corresponds to a plurality of concurrently executing processes, and wherein the determining the plurality of downtime windows
maximizes a likelihood that a maximum of available resources of the IT system are available for the concurrently executing processes during a time spanned by the downtime windows.

17. The computer program product of claim 16, wherein the generating the maintenance schedule comprises generating a constraint-based scheduler based on the plurality of downtime windows and at least one of a maintenance task priority, IT resource availability, and current time.

18. The computer program product of claim 14, wherein the current IT data indicates an IT system failure, and wherein the generating the maintenance schedule to performance maintenance on IT system elements affected by the IT system failure.

19. The computer program product of claim 14, wherein the program instructions are executable by the processor to cause the processor to initiate operations further including:
receiving data indicating an environmental factor that affects the one or more KPI metrics; and
generating the maintenance schedule based on the environmental factor and the one or more KPI metrics.

20. The computer program product of claim 19, wherein the environmental factor corresponds to at least one of a weather condition, supply chain disruption, or communication network disruption.
